(19) United States
(12) Patent Application Publication
(10) Pub. No.: US 2018/0345894 A1
(43) Pub. Date: Dec. 6, 2018

(54) CAPACITIVE OCCUPANT DETECTION SYSTEM WITH ISOFIX DISCRIMINATION

(71) Applicant: IEE INTERNATIONAL ELECTRONICS & ENGINEERING S.A., Echternach (LU)

(72) Inventors: Frank ALTHAUS, Saarbrucken (DE); Erik HOLZAPFEL, Prum (DE); Arnaud MEURENS, Aubange (BE); Ingrid SCHECKENBACH, Ferschweiler (DE); Daniel FERRING, Zemmer (DE); Oleg ZEILER, Bahnhofstrasie (DE); Guenter GOEDERT, Trier (DE); Edmund MARX, Speicher (DE); Michael PUETZ, Trier (DE)

(21) Appl. No.: 16/062,391

(22) PCT Filed: Dec. 2, 2016
(86) PCT No.: PCT/EP2016/079615

§ 371 Date: Jun. 14, 2018

(30) Foreign Application Priority Data
Dec. 15, 2015 (LU) 92 910

(51) Int. Cl. B60R 21/015; B60N 2/00

(52) U.S. Cl. CPC B60R 21/01532; B60R 22/48; B60N 2/002

(57) ABSTRACT

In addition to the loading mode of a capacitive sensing device of a seat occupancy detection and classification system, a second measurement mode is introduced, which allows a discrimination of objects (CRS or human) with and without grounding condition. Depending on the value of the new measurement, the data is allocated to different groups which are subject to different thresholds in the loading mode. This means that if the new measurement indicates a grounding condition of the object, a higher threshold in the loading mode will be applied. In this way CRS with grounding condition will be classified by means of the higher threshold, resulting in a robustness increase. Typical human sitting positions do not show a grounding condition and will be classified by the lower threshold.

### TECHNICAL FIELD

The invention relates to a capacitive sensing device, a seat occupancy detection and classification system comprising such capacitive sensing device, a method of operating such capacitive seat occupancy detection and classification system and a software module for carrying out the method.

### BACKGROUND OF THE INVENTION

Seat occupant detection and/or classification devices are nowadays widely used in vehicles, in particular in passenger cars, for providing a seat occupant signal for various appliances, for instance for the purpose of a seat belt reminder (SBR) system or an activation control for an auxiliary restraint system (ARS). Seat occupant detection and/or classification systems include seat occupant sensors that are known to exist in a number of variants, in particular based on capacitive sensing. An output signal of the seat occupant detection and/or classification system is usually transferred to an electronic control unit of the vehicle to serve, for instance, as a basis for a decision to deploy an air bag system to the vehicle seat.

A capacitive sensor, called by some electric field sensor or proximity sensor, designates a sensor, which generates a signal responsive to the influence of what is being sensed (a person, a part of a person's body, a pet, an object, etc.) upon an electric field. A capacitive sensor generally comprises at least one antenna electrode, to which is applied an oscillating electric signal and which thereupon emits an electric field into a region of space proximate to the antenna electrode, while the sensor is operating. The sensor comprises at least one sensing electrode which could comprise the one or more antenna electrodes themselves at which the influence of an object or living being on the electric field is detected.

The different capacitive sensing mechanisms are for instance explained in the technical paper entitled “Electric Field Sensing for Graphical Interfaces” by J. R. Smith et al., published in IEEE Computer Graphics and Applications, 18(3): 54-60, 1998. The paper describes the concept of electric field sensing as used for making non-contact three-dimensional position measurements, and more particularly for sensing the position of a human hand for purposes of providing three-dimensional positional inputs to a computer. Within the general concept of capacitive sensing, the author distinguishes between distinct mechanisms he refers to as “loading mode”, “shunt mode”, and “transmit mode” which correspond to various possible electric current pathways. In the “loading mode”, an oscillating voltage signal is applied to a transmit electrode, which builds up an oscillating electric field to ground. The object to be sensed modifies the capacitance between the transmit electrode and ground. In the “shunt mode”, which is alternatively referred to as “coupling mode”, an oscillating voltage signal is applied to the transmit electrode, building up an electric field to a receive electrode, and the displacement current induced at the receive electrode is measured, whereby the displacement current may be modified by the body being sensed. In the “transmit mode”, the transmit electrode is put in contact with the user's body, which then becomes a transmitter relative to a receiver, either by direct electrical connection or via capacitive coupling.

The capacitive coupling is generally determined by applying an alternating voltage signal to a capacitive antenna electrode and by measuring the current flowing from said antenna electrode either towards ground (in the loading mode) or into the second electrode (receiving electrode) in case of the coupling mode. This current is usually measured by means of a transimpedance amplifier, which is connected to the sensing electrode and which converts a current flowing into said sensing electrode into a voltage, which is proportional to the current flowing into the antenna electrode.

Some capacitive sensors are designed as sense-only capacitive sensors having a single sense electrode. Also, quite often capacitive sensors are used that comprise a sense electrode and a guard electrode that are proximally arranged and mutually insulated from each other. This technique of “guarding” is well known in the art and is frequently used for intentionally masking, and thus shaping, a sensitivity regime of a capacitive sensor. To this end, the guard electrode is kept at the same electric AC potential as the sense electrode. As a result, a space between the sense electrode and the guard electrode is free of an electric field, and the guard-sense capacitive sensor is insensitive in a direction between the sense electrode and the guard electrode.

Capacitive occupant sensing systems have been proposed in great variety, e.g. for controlling the deployment of one or more airbags, such as e.g. a driver airbag, a passenger airbag and/or a side airbag. U.S. Pat. No. 6,161,070, to Jinno et al., relates to a passenger detection system including a single antenna electrode mounted on a surface of a passenger seat in an automobile. An oscillator applies on oscillating voltage signal to the antenna electrode, whereby a minute electric field is produced around the antenna electrode. Jinno proposes detecting the presence or absence of a passenger in the seat based on the amplitude and the phase of the current flowing to the antenna electrode.

U.S. Pat. No. 6,392,542 to Stanley teaches an electric field sensor comprising an electrode mountable within a seat and operatively coupled to a sensing circuit, which applies to the electrode an oscillating or pulsed signal having a frequency “at most weakly responsive” to wetness of the seat. Stanley proposes to measure phase and amplitude of the current flowing to the electrode to detect an occupied or an empty seat and to compensate for seat wetness.

Others had the idea of using the heating element of a seat heater as an antenna electrode of a capacitive occupancy sensing system. International application WO 92/17344 A1 discloses an electrically heated vehicle seat with a conductor, which can be heated by the passage of electrical current, located in the seating surface, wherein the conductor also forms one electrode of a two-electrode seat occupancy sensor.

International application WO 95/13204 A1 discloses a similar system, in which the oscillation frequency of an oscillator connected to the heating element is measured to derive the occupancy state of the vehicle seat. More elaborate combinations of a seat heater and a capacitive sensor are disclosed, for instance, in U.S. Pat. No. 7,521,940 B2, US 2009/0295199 A1 and U.S. Pat. No. 6,703,845.

Capacitive antenna electrodes are generally designed in order to substantially cover the entire seating surface of the vehicle seat. This ensures that a passenger may be reliably detected even if the passenger is sitting in an unnatural way on the seat, e.g. on the front-most position of the vehicle seat.

The capacitive sensing system should be able to distinguish an empty seat or a seat equipped with a child restraint system (CRS), from a person directly sitting on the seat.

A reliable capability of distinguishing between potential seat occupant classes is essential for fulfilling high safety requirements. Compared to vehicle seat classification systems conducting mechanical load-based resistive measurements that are also known in the art, a capacitive measurement has the advantages of a simpler wiring and a stable and reproducible measurement over an entire temperature range as specified in common vehicle requirements.

A seat occupant detection and classification system, in particular for detecting and classifying a seat occupancy of a vehicle seat, based on capacitive sensing measures a physical quantity, for instance an electric current through a capacitive sensor member or a complex impedance or admittance of the capacitive sensor member, wherein the physical quantity is representative of an electric field between at least one sense electrode of the capacitive sensor member and a vehicle body.

The at least one sense electrode may be positioned on or inside the vehicle seat. A seat occupant or an object which is placed on the vehicle seat will modify the electric field of the sense electrode, resulting in a change of the measured physical quantity.

The seat occupancy detection and classification system is a capacitive measurement system which is used inside the passenger seat of a vehicle to classify if either an adult is sitting on the seat or the seat is empty or occupied with a child restraint system (CRS).

A problem concerning a capacitive sensing device, measuring a capacitive coupling between an antenna electrode and vehicle ground might occur as follows:
with a standard CRS, i.e. a non-grounded CRS installed on the seat by means of the seat belt, a seat equipped with a CRS is sensed as low capacity, whereas a person sitting directly on seat is sensed as high capacitance;
with a grounded CRS, i.e. with an ISOFIX CRS which is electrically connected to the vehicle ground, the system senses a high capacitance, which may create a misclassification.

In this way, vehicle seat occupant classification systems based on capacitive sensing are subject to being misled in the case of vehicle-grounded objects being placed on a vehicle seat, for instance an ISOFIX CRS, that in an installed state is grounded by mechanically connecting the CRS to anchorages that are fixedly attached to the vehicle body. ISOFIX child restraint systems are equipped with metallic clips that are configured for quick fixation at the anchorages. The metallic clips are part of a metal frame arranged inside the CRS. This metal frame could come close to the antenna electrode within a few millimeters. Depending on the proximity of the grounded CRS metal frame to the at least one antenna electrode of the capacitive sensor member, the sensed physical quantity might be large enough to cause the vehicle seat occupant classification system to classify a CRS electrically connected to vehicle ground as a “person sitting directly on seat”.

In such cases, an ability of the vehicle seat occupant classification system to correctly classify a seat occupant might be affected. In the same way, any object that is connected to vehicle ground may lead to a misclassification by the vehicle seat occupant classification system due to a relatively small distance between the capacitive sensor member and the grounded object.

### SUMMARY

It is therefore an object of the present invention to provide a seat occupant classification system with high functional robustness, in particular a vehicle seat occupant classification system, that is able to reliably and correctly classify a seat occupancy without the above described shortcomings, and which particularly enables a correct classification of a CRS that is being installed with ISOFIX system and that is electrically connected to vehicle ground.

In one aspect of the present invention, the object is achieved by a capacitive sensing device for a seat occupancy detection and classification system. The capacitive sensing device includes an impedance measurement circuit and a signal processing unit.

The impedance measurement circuit comprises a signal voltage source that is configured for providing, with reference to a ground potential, a periodic electrical measurement signal at an output port, and at least one sense current measurement means that is configured to measure complex sense currents with reference to a reference voltage.

A capacitive sensor that includes at least a first electrically conductive antenna electrode and a second electrically conductive antenna electrode is electrically connectable to the impedance measurement circuit such that
at least the first antenna electrode is electrically connectable to the output port for receiving the electrical measurement signal, and
the second antenna electrode is electrically connectable via at least one controllable, preferably remote controllable, switch member either to the ground potential or to an electric AC potential of the output port.

The complex sense currents are being generated in the capacitive sensor by the provided periodic measurement signal.

The phrase “electrically connectable/ electrically connected”, as used in this application, shall be understood to encompass galvanic electrical connections as well as electrical connections established by capacitive and/or inductive electromagnetic coupling. The phrase “being configured to”, as used in this application, shall in particular be understood as being specifically programmed, laid out, furnished or arranged.

It is further noted herewith that the terms “first” and “second” are used in this application for distinction purposes only, and are not meant to indicate or anticipate a sequence or a priority in any way.

The signal processing unit is configured to determine complex impedances from measured currents at least through the first antenna electrode with reference to the complex reference potential, and to provide output signals that are representative of the determined complex impedances.

The invention is based on the concept to eliminate the largest unknown in the setup of a seat occupancy, which is the grounding condition of an object that is arranged on the seat, prior to further determining complex impedances from measured currents for detecting and classifying of the seat occupancy. In this way, occurrence of measurement conditions with ambiguities regarding classifying seat occupancies can be prevented, and a capacitive sensing device with improved robustness with regard to detecting seat occupancies, particularly in the presence of grounded objects, can be provided.

The at least one controllable switch member may form part of the capacitive sensing device, or it may form part of another device that is separate from the capacitive sensing device and that is operatively coupled to the capacitive sensing device.

Instead of determining complex impedances from measured currents, the signal processing unit may be configured to determine complex admittances from measured currents without any change of the disclosed subject-matter of the invention, as the real parts and the imaginary parts of a complex impedance and its corresponding complex admittance are interrelated by a one-to-one correspondence, as will readily be appreciated by those skilled in the art.

In particular, the capacitive sensing device may be used for a vehicle seat occupancy detection and classification system. The term “vehicle”, as used in this application, shall particularly be understood to encompass passenger cars, trucks and buses.

Preferably, the capacitive sensor is operated in loading mode as described in the above-mentioned article Electric field sensing for graphical interfaces by J. Smith et al., which shall hereby be incorporated by reference in its entirety with effect for the jurisdictions permitting incorporation by reference. In general, it is also contemplated to operate the capacitive sensor in transmit mode or in shunt mode in some embodiments or in some modes of operation.

Preferably, the first electrically conductive antenna electrode and the second electrically conductive antenna electrode are mutually galvanically separate from each other. The term “galvanically separate”, as used in this application, shall particularly be understood to not conduct an electric direct current (DC) between galvanically separate objects.

In one aspect of the present invention, the object is achieved by a seat occupancy detection and classification system, in particular a vehicle seat occupancy detection and classification system, including a capacitive sensing device as disclosed herein, wherein the capacitive sensor is electrically connectable to the impedance measurement circuit such that a current flowing into or through the second antenna electrode may be measured by the impedance measurement circuit. The signal processing unit is further configured to at least determine a complex impedance from a measured current through the second antenna electrode that is determined with reference to the complex reference potential.

The seat occupancy detection and classification system further comprises a control and evaluation unit that is configured
to receive the output signals provided by the signal processing unit,
dependent on a result of the complex impedance from the measured current through the second antenna electrode, to select at least one threshold value out of predetermined threshold values for complex impedance,
to compare the complex impedances from the measured current through the first antenna electrode to the at least one selected predetermined threshold value, and,
based on the result of the comparing, to determine a seat occupancy class.

The current through the second antenna electrode may be measured by the at least one sense current measurement means of the impedance measurement circuit. Alternatively, the impedance measurement circuit may include a second sense current measurement means for this purpose.

In addition to the regular operation mode, the present invention proposes to introduce a second measurement mode which allows a discrimination of objects (CRS or human) with and without grounding condition. Depending on the value of the new measurement the data is allocated to different groups which are subject to different thresholds in the loading mode. This means if the new measurement indicates a grounding condition of the object, a different threshold in the regular operation mode will be applied. In this way, a CRS with grounding condition will be classified by means of the different threshold, which leads to a robustness increase. Typical human positions do not show a grounding condition and will be classified by the first threshold.

The proposed system is an (almost) CRS design-independent solution for ISOFIX CRS.

FIG. 5A to 5C schematically illustrate the principle that an operation of the seat occupancy detection and classification system is based on. FIG. 5A is a schematic side view of an adult seat occupant arranged on the vehicle seat. The adult seat occupant is not electrically connected to ground. Due to the electric interaction between the seat occupant and the first and second antenna, which are arranged at a seat cushion of the vehicle seat, an electric current provided to the first antenna electrode causes an electric current flowing through to the second antenna electrode. A measured total capacitance which is derived from the determined complex impedance of this configuration is equal to the capacitance of two capacitors electrically connected in parallel, wherein one capacitor is formed by the first antenna electrode and the seat occupant and the other capacitor is formed by the second antenna electrode and the seat occupant. Thus, the seat occupant creates a relatively large current in the second antenna electrode of the capacitive sensing device.

FIG. 5B is a schematic side view of a child restraint system (CRS) that is arranged on the vehicle seat but is not mechanically and electrically connected to anchorages which are fixedly attached to the vehicle body. An electric current provided to the first antenna electrode causes an electric current flowing through the second antenna electrode that is determined by the electromagnetic coupling governed by the geometric relationship between the two antenna electrodes, and is not enhanced by the CRS due to the low electromagnetic coupling between each one of the antenna electrodes and the CRS.

FIG. 5C is a schematic side view of a child restraint system (CRS) that is arranged on the vehicle seat and is mechanically and electrically connected to anchorages which are fixedly attached to the vehicle body. An electric current provided to the first antenna electrode does not cause an electric current flowing through to the second antenna electrode because the current is flowing through the grounded CRS to ground (the vehicle body).

In this way, the additional information on the grounding condition of the object arranged on the seat obtained by the signal of the second antenna electrode can beneficially be used to select an appropriate threshold value out of predetermined threshold values for complex impedance. The signal obtained by the first antenna electrode can then be compared to the appropriate threshold value for robust and reliable seat occupancy detection and classification.

The object is also achieved by a seat occupancy detection and classification system, in particular a vehicle seat occupancy detection and classification system, including a capacitive sensing device as disclosed herein, wherein the capacitive sensor is electrically connectable to the impedance measurement circuit such that the second antenna electrode is electrically connectable via the at least one (remote) controllable switch member either to the ground potential or to the electric AC potential of the output port. The signal processing unit is further configured to at least determine a first complex impedance from a measured current through the first antenna electrode with the second antenna electrode being electrically connected to the electric DC potential, and to determine a second complex impedance from a measured current through the first antenna electrode with the second antenna electrode being electrically connected to the electric AC potential of the output port.

The seat occupancy detection and classification system further comprises a control and evaluation unit that is configured
to receive the output signals provided by the signal processing unit,
dependent on a relation between the first and the second complex impedance, to select at least one threshold value out of predetermined threshold values for complex impedance,
to compare the complex impedances from the measured current through the first antenna electrode to the at least one selected predetermined threshold value, and,
based on the result of the comparing, to determine a seat occupancy class.

In case a grounding condition of the object arranged on the seat is present, virtually no difference between the first and the second complex impedance can be measured, as the grounded object acts as an electromagnet shield with regard to the second antenna electrode. This can beneficially be exploited for distinction between a grounded and an ungrounded object arranged on the seat, and for selecting an appropriate threshold value out of predetermined threshold values for complex impedance. The signal obtained by the first antenna electrode can then be compared to the appropriate threshold value for robust and reliable seat occupancy detection and classification.

It should be noted, that instead of actually determining the first complex impedance and the second complex impedance and selecting the threshold dependent on a relation between the first and the second complex impedance, the signal processing unit may be configured to at least determine only a difference between a first complex impedance of the first antenna electrode with the second antenna electrode being electrically connected to the ground potential and a second complex impedance of the first antenna electrode with the second antenna electrode being electrically connected to the electric AC potential of the output port.

In such an embodiment, the capacitive sensor is electrically connectable to the impedance measurement circuit such that the second antenna electrode is electrically connectable via the at least one controllable switch member alternately to the ground potential and to the electric AC potential of the output port, and the control and evaluation unit that is configured to select at least one threshold value dependent on the difference between the first and the second complex impedance. In other words, such an implementation uses a “modulation” of the second antenna (between ground and AC potential) and bases the further evaluation on the difference of the impedances (as a result of demodulation).

In some embodiments of the seat occupancy detection and classification system, the capacitive sensing device comprises at least one remote controllable switch member and the seat occupancy detection and classification system comprises a switch remote control unit for remotely controlling the at least one remote controllable switch member.

In this way, a reliable distinction between a grounded and an ungrounded object arranged on the seat for selecting an appropriate threshold value out of predetermined threshold values for complex impedance can be accomplished.

Preferably, the switch remote control unit is formed by a microcontroller. Microcontrollers that are suitably equipped and include, for instance, a processor unit, a digital data memory unit, a microcontroller system clock, a multiplexer unit and analog-to-digital converters are nowadays readily available in many variations.

In some preferred embodiments of the capacitive seat occupancy detection and classification system, the switch remote control unit is configured to periodically switch the remote controllable switch member to change an electrical connection of the second antenna electrode from being electrically connected to the electric ground potential to being electrically connected to the electric AC potential of the output port for a predetermined time period and back to being electrically connected to the electric ground potential after the time period has elapsed. When a suitable predetermined time period is selected, a quasi-continuous operation of the seat occupancy detection and classification system can be accomplished with virtually no restriction to operational availability.

In a preferred embodiment, a capacitive sensor that is electrically connected at least to the output port of the signal voltage source and to the sense current measurement means forms part of the capacitive seat occupancy detection and classification system. By that, a complete seat occupancy detection and classification system with the above-mentioned benefits can be provided.

In another preferred embodiment of the capacitive seat occupancy detection and classification system, the control and evaluation unit is configured to generate a classification output signal that is indicative of the determined seat occupancy class. The classification output signal of the control and evaluation unit can beneficially be transferred to an electronic control unit of the vehicle to serve, for instance, as a basis for a decision to deploy an air bag system to the vehicle seat.

In some embodiments of the capacitive seat occupancy detection and classification system, the at least one threshold value out of predetermined threshold values for complex impedance can be represented by a line in a two-dimensional graph spanned by a real part and an imaginary part of the complex impedance. In this way, flexible and adaptable conditions for distinguishing between seat occupancy classes can be created.

In yet another aspect of the present invention, the object is achieved by a method of operating one of the disclosed capacitive seat occupancy detection and classification systems, wherein the capacitive sensor is electrically connectable to the impedance measurement circuit such that a current through the second antenna electrode is measurable by said impedance measurement circuit.

The method includes steps of
providing a periodic electrical measurement signal to the first antenna electrode of the capacitive sensor,
determining a complex sense current that is being generated in the second antenna electrode of the capacitive sensor in response to the periodic electrical measurement signal provided to the first antenna electrode of the capacitive sensor,
comparing the determined complex sense current to at least one predetermined threshold value for the complex sense current,
depending on the result of the step of comparing, selecting at least one threshold value out of predetermined threshold values for complex impedance,
determining a complex sense current that is being generated in the first antenna electrode of the capacitive sensor in response to the periodic electrical measurement signal provided to the first antenna electrode of the capacitive sensor,
determining a complex impedance from the complex sense current in the first antenna electrode measured with reference to the complex reference potential,
comparing the determined complex impedance to the at least one selected predetermined threshold value for complex impedance, and
determining a seat occupancy class for the determined complex impedance depending on a relation between the determined complex impedance and the at least one selected predetermined threshold value for complex impedance.

The relation between the determined complex impedance and the at least one selected predetermined threshold value for complex impedance may be one out of “larger than”, “lower than” or “equal to”. The relation may also comprise a constant factor, such as for instance “larger than 1.2 times”.

The object is also achieved by a method of operating one of the disclosed capacitive seat occupancy detection and classification systems, wherein the capacitive sensor is electrically connectable to the impedance measurement circuit such that the second antenna electrode is electrically connectable via the at least one remote controllable switch member either to the ground potential or to the electric AC potential of the output port.

The method includes steps of
providing a periodic electrical measurement signal to the first antenna electrode of the capacitive sensor,
electrically connecting the second antenna electrode to the ground potential,
determining a first complex sense current that is being generated in the first antenna electrode of the capacitive sensor in response to the periodic electrical measurement signal provided to the first antenna electrode of the capacitive sensor,
determining a first complex impedance from the determined first complex sense current in the first antenna electrode measured with reference to the complex reference potential,
changing the electrically connection of the second antenna electrode from the ground potential to the electric AC potential of the output port,
determining a second complex sense current that is being generated in the first antenna electrode of the capacitive sensor in response to the periodic electrical measurement signal provided to the first antenna electrode of the capacitive sensor,
determining a second complex impedance from the determined first complex sense current in the first antenna electrode measured with reference to the complex reference potential,
determining a difference of the first complex impedance and the second complex impedance,
comparing the determined difference of the first complex impedance and the second complex impedance to at least one predetermined threshold value for the difference of complex impedance,
depending on the result of the step of comparing, selecting at least one threshold value out of predetermined threshold values for complex impedance,
comparing the determined first complex impedance to the at least one selected predetermined threshold value for complex impedance,
determining a seat occupancy class for the determined first complex impedance depending on a relation between the determined first complex impedance and the at least one selected predetermined threshold value for complex impedance.

Regarding the relation between the determined complex impedance and the at least one selected predetermined threshold value for complex impedance, the above applies.

The object is also achieved by a method of operating one of the disclosed capacitive seat occupancy detection and classification systems, wherein the capacitive sensor is electrically connectable to the impedance measurement circuit such that the second antenna electrode is electrically connectable via the at least one remote controllable switch member alternately to the ground potential and to the electric AC potential of the output port.

The method includes steps of
providing a periodic electrical measurement signal to the first antenna electrode of the capacitive sensor,
alternately connecting the second antenna electrode to the ground potential and to the electric AC potential of the output port,
determine a difference between a first complex impedance of the first antenna electrode with the second antenna electrode being electrically connected to the ground potential and a second complex impedance of the first antenna electrode with the second antenna electrode being electrically connected to the electric AC potential of the output port,
comparing the determined difference of the first complex impedance and the second complex impedance to at least one predetermined threshold value for the difference of complex impedance,
depending on the result of the step of comparing, selecting at least one threshold value out of predetermined threshold values for complex impedance,
comparing the determined first complex impedance to the at least one selected predetermined threshold value for complex impedance,
determining a seat occupancy class for the determined first complex impedance depending on a relation between the determined first complex impedance and the at least one selected predetermined threshold value for complex impedance.

In one embodiment, the method steps may be carried out automatically and periodically.

In yet another aspect of the invention, a software module for controlling an automatic execution of steps of an embodiment of the method disclosed herein is provided.

The method steps to be conducted are converted into a program code of the software module, wherein the program code is implementable in a digital data memory unit of the capacitive vehicle seat occupancy detection and classification system and is executable by a processor unit of the capacitive vehicle seat occupancy detection and classification system. Preferably, the digital data memory unit and/or processor unit may be a digital data memory unit and/or a processing unit of the evaluation unit of the capacitive vehicle seat occupancy detection and classification system. The processor unit may, alternatively or supplementary, be another processor unit that is especially assigned to execute at least some of the method steps.

The software module can enable a robust and reliable execution of the method and can allow for a fast modification of method steps.

In yet another aspect of the invention, as seat, in particular a vehicle seat, with an installed capacitive seat occupant detection and classification system as disclosed herein is provided. The seat comprises a seat cushion having at least one seat foam member and a seat base that is configured for receiving at least a portion of the seat cushion. The seat base and the seat cushion are provided for supporting a bottom of a seat occupant. The seat further includes a backrest that is provided for supporting a back region of the seat occupant. The capacitive sensor is arranged at at least one out of the seat cushion and the backrest.

In this way, a seat, in particular a vehicle seat, with a robust and reliable seat occupancy detection and classification can be provided.

Moreover, the seat may be equipped with at least a pair of anchorages configured for mechanically engaging with corresponding fixation members of a CRS.

In a preferred embodiment of the seat, at least one out of the first antenna electrode and the second antenna electrode is formed by an electrical seat heater member that is installed in the seat. This embodiment combines the advantage of a robust and reliable seat occupancy detection and classification with the benefit of hardware savings.

### BRIEF DESCRIPTION OF THE DRAWINGS

Further details and advantages of the present invention will be apparent from the following detailed description of not limiting embodiments with reference to the attached drawing, wherein:

FIG. 1 schematically illustrates a vehicle seat with a first installed embodiment of a seat occupancy detection and classification system in accordance with the invention;

FIG. 2 schematically illustrates details of the functional principle of the seat occupancy detection and classification system in accordance with the invention; and

FIG. 3 schematically shows details of the first installed embodiment of the seat occupancy detection and classification system in accordance with the invention;

FIG. 4 schematically shows the vehicle seat with a second installed embodiment of the seat occupancy detection and classification system in accordance with the invention;

FIGS. 5A to 5C schematically illustrate details of the operating principle of the seat occupancy detection and classification system in accordance with the invention; and

FIG. 6 is a flowchart of an embodiment of a method in accordance with the invention of operating the seat occupancy detection and classification system pursuant to FIG. 1.

### DESCRIPTION OF THE ILLUSTRATED EMBODIMENTS

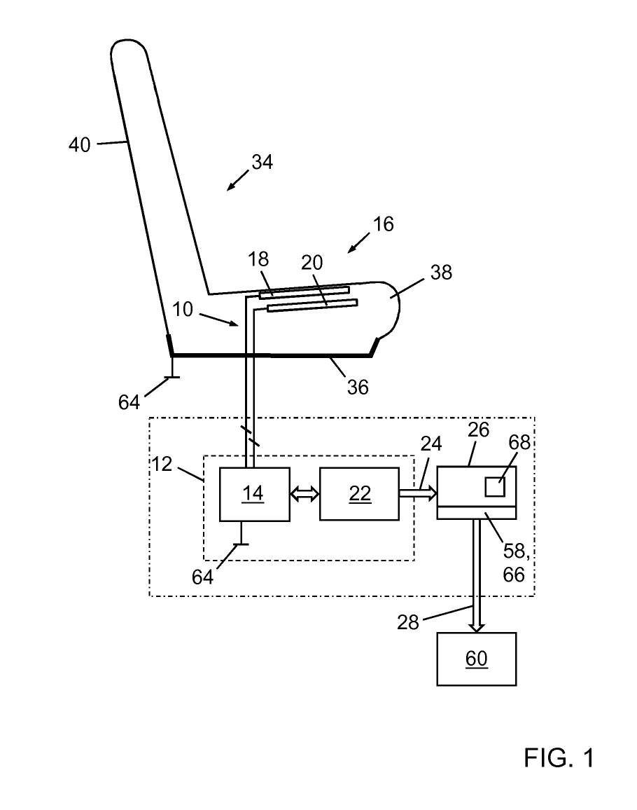

FIG. 1 schematically shows a seat 34 formed as a vehicle seat, comprising a capacitive seat occupancy detection and classification system 10 in accordance with an embodiment of the invention. The vehicle seat is designed as a seat of a passenger car and includes a seat structure (not shown) by which it is erected on a passenger cabin floor of the passenger car, as is well known in the art.

The seat 34 further includes a seat base 36 supported by the seat structure and configured for receiving a seat cushion 38 for providing comfort to a seat occupant. The seat cushion 38 of the vehicle seat comprises a seat foam member and a fabric cover, which has been omitted in FIG. 1. The seat base 36 and the seat cushion 38 are provided for supporting a bottom of the seat occupant. A backrest 40 of the seat 34 is provided for supporting a back of the seat occupant.

The vehicle seat occupant detection and classification system 10 includes a capacitive sensor 16, a capacitive sensing device 12 and a control and evaluation unit 26. The capacitive sensor 16 is located on the A-surface of the seat cushion 38, underneath the fabric cover. The capacitive sensing device 12 and the control and evaluation unit 26 are installed in the vehicle, remote from the vehicle seat. An output port of the control and evaluation unit 26 is connected to an airbag control unit 60. The capacitive sensing device 12 comprises an impedance measurement circuit 14 and a signal processing unit 22.

The impedance measurement circuit 14 includes a signal voltage source that is configured for providing, with reference to a ground potential 64, a periodic electrical measurement signal at an output port, and a sense current measurement means that is configured to measure complex sense currents with reference to a reference voltage. The sense current measurement means may be formed as a transimpedance amplifier, which is connected to a sensing antenna electrode and which converts a current flowing into the sensing antenna electrode into a voltage, which is proportional to the current flowing into the sensing antenna electrode. In principle, any other sense current measurement means could be employed that appears to be suitable to those skilled in the art.

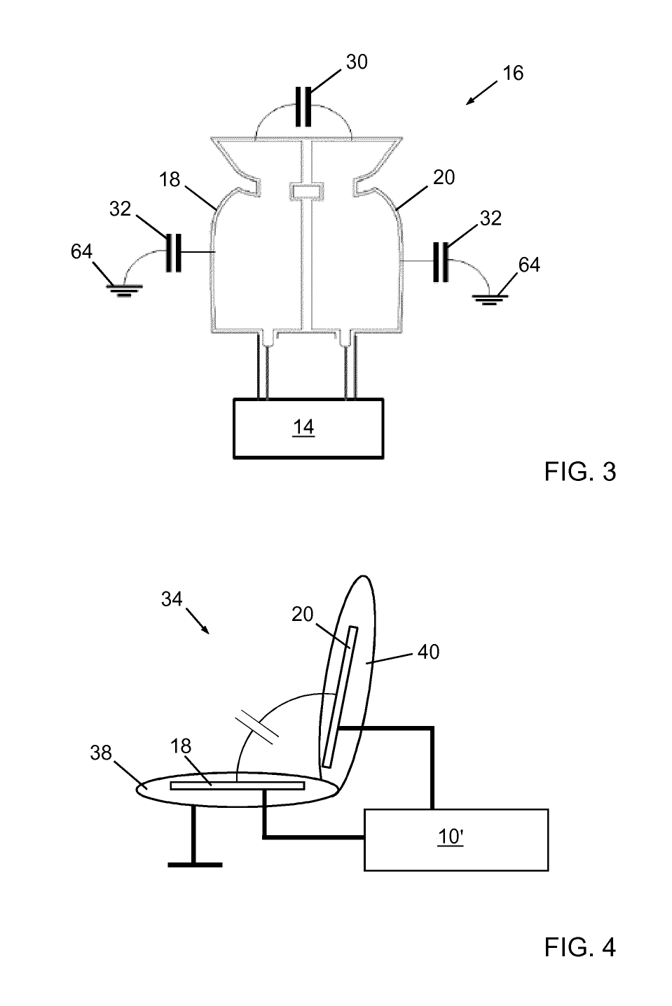

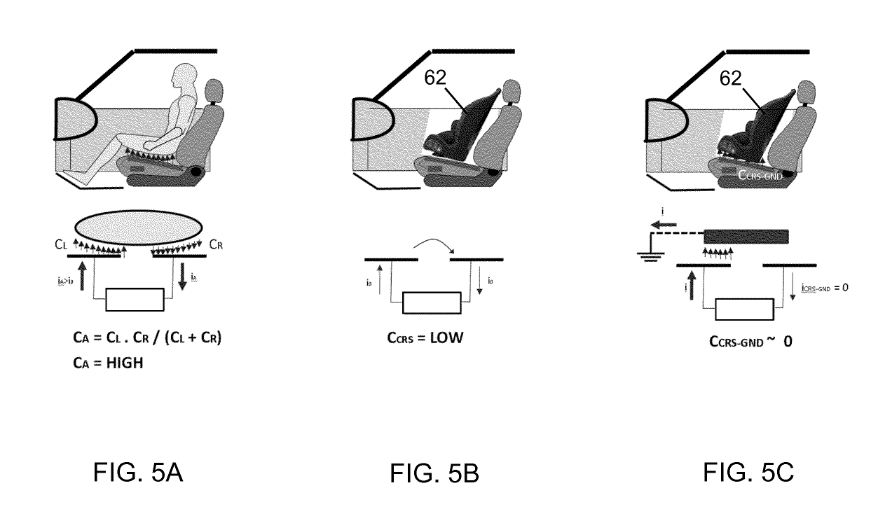

The capacitive sensor 16 comprises a first electrically conductive antenna electrode 18 and a second electrically conductive antenna electrode 20 that are arranged side by side at the seat cushion A surface, mutually galvanically separate from each other (FIG. 3). The first antenna electrode 18 and the second antenna electrode 20 are capacitively coupled, which is indicated by a capacitor 30 shown as electrically connected to both antenna electrodes 18, 20. An object approaching the antenna electrodes 18, 20 is represented by an unknown capacitor 32 that is connected to the ground potential 64, which for instance may be a vehicle ground potential. If the object approaches the antenna electrodes 18, 20, the respective unknown capacitor 32 changes its capacitance, and a sense current flowing between the antenna electrode 18, 20 and ground potential 64 changes.

The first antenna electrode 18 and the second antenna electrode 20 are made e.g. from thin aluminum foil or, alternatively, from an aluminized plastic material such as polyethylene terephthalate (PET). The capacitive sensor 16 is electrically connected to the impedance measurement circuit 14 such that the first antenna electrode 18 is electrically connected to the output port for receiving the electrical measurement signal. The second antenna electrode 20 is electrically connectable via a remote controllable switch member either to the ground potential 64 or to an electric AC potential of the output port. For this specific embodiment, it shall be presumed that the second antenna electrode 20 is connected to the impedance measurement circuit 14 such that a current through the second antenna electrode 20 is measurable by said impedance measurement circuit 14.

In this specific embodiment, both the antenna electrodes 18, 20 are made from thin aluminum foil. In an alternative embodiment, only the first antenna electrode 18 is made from thin aluminum foil, and the second antenna electrode 20 is formed by an electrical seat heater member that is installed in the vehicle seat, as is well known in the art. The operating principle of the capacitive seat occupancy detection and classification system 10 disclosed herein as well applies to such an alternative embodiment.

The complex sense currents to be sensed by the current measurement means are being generated in first electrically conductive antenna electrode 18 of the capacitive sensor 16 by the provided periodic measurement signal, i.e. the regular operating mode of the capacitive sensor 16 is the loading mode.

The signal processing unit 22 is configured to determine complex impedances from measured currents through the first antenna electrode 18 with reference to the complex reference potential, which is given by the electrical measurement signal. Moreover, the signal processing unit 22 is configured to provide output signals 24 that are representative of the determined complex impedances.

The control and evaluation unit 26 is configured to receive the output signals 24 provided by the signal processing unit 22.

With the second antenna electrode 20 being connected to the impedance measurement circuit 14, the signal processing unit 22 is further configured to determine a complex impedance from a measured complex current through the second antenna electrode 20 determined with reference to the complex reference potential.

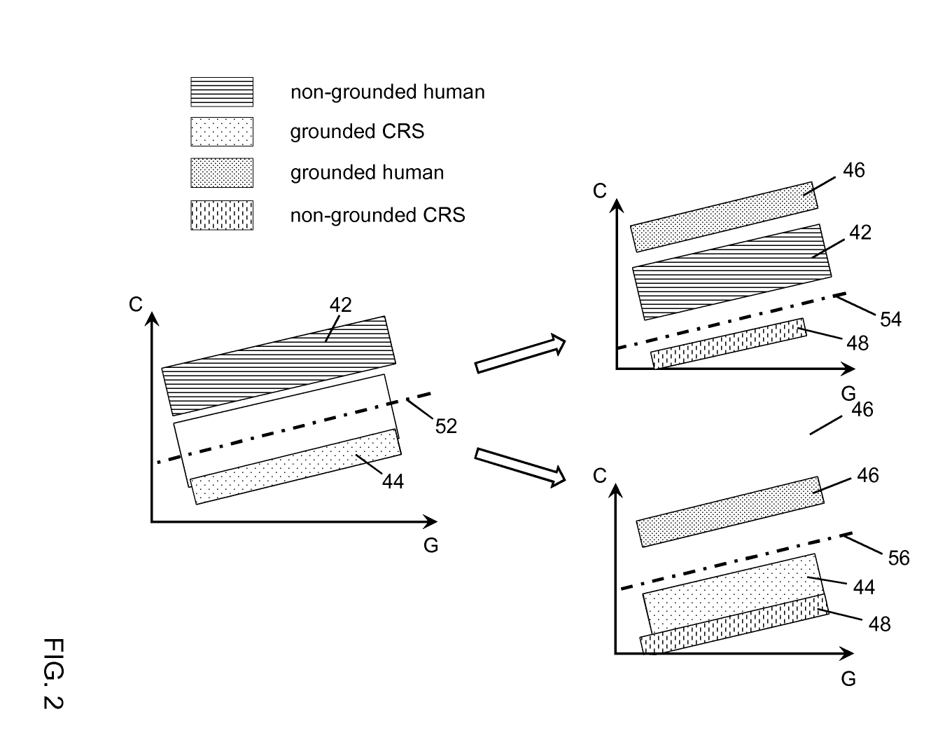

FIG. 2 schematically illustrates details of the functional principle of the seat occupancy detection and classification system 10. The diagrams show the real part (expressed as conductance G) and the imaginary part (expressed as capacitance C) of determined complex impedances. A first zone 42 in the left-hand diagram represents complex impedances to be expected with the seat occupant being a non-grounded human being. A second zone 44 represents complex impedances to be expected with the seat occupant being a grounded CRS 62. A dash-dotted first line 52 in the two-dimensional graph represents predetermined threshold values for the complex current (expressed as complex impedances) to distinguish between the first 42 and the second zone 44.

Depending on a position of the result of the complex impedance from the measured complex current through the second antenna electrode 20 with regard to the dash-dotted first line 52, the control and evaluation unit 26 is configured to select at least one threshold value out of predetermined threshold values for complex impedance, as is exemplarily shown in the two right-hand diagrams of FIG. 2.

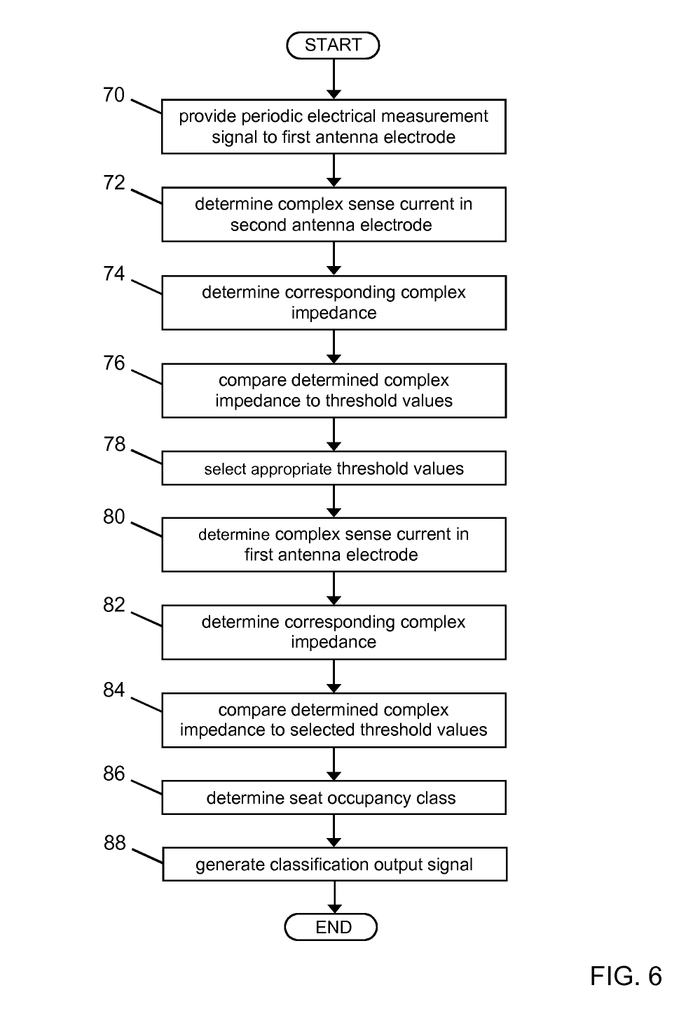

In the following, an embodiment of a method of operating the capacitive seat occupancy detection and classification system 10 pursuant to FIG. 1 will be described. A flowchart of the method is provided in FIG. 6. In preparation of using the capacitive seat occupancy detection and classification system 10, it shall be understood that all involved units and devices are in an operational state and configured as illustrated in FIG. 1.

In order to be able to carry out the method, the control and evaluation unit 26 comprises a software module 58. The method steps to be conducted are converted into a program code of the software module 58. The program code is implemented in a digital data memory unit 66 of the control and evaluation unit 26 and is executable by a processor unit 68 of the control and evaluation unit 26. Alternatively, the software module 58 may as well reside in and may be executable by a control unit of the vehicle, for instance by the airbag control unit 60, and established data communication means between the control and evaluation unit 26 and the airbag control unit 60 of the vehicle would be used for enabling mutual transfer of data.

In a first step 70 of the method, a periodic electrical measurement signal is provided to the first antenna electrode 18 of the capacitive sensor 16. Then, a complex sense current that is being generated in the second antenna electrode 20 of the capacitive sensor 16 in response to the periodic electrical measurement signal provided to the first antenna electrode 18 of the capacitive sensor 16 is determined by the sense current measurement means in another step 72. The determining of the complex sense current with reference to the complex reference potential is followed by a step 74 of determining a corresponding complex impedance by the signal processing unit 22. In the next step 76, the determined complex impedance is compared to the predetermined threshold values for the complex impedance represented by the dash-dotted first line 52 in the left-hand diagram of FIG. 2.

Depending on the result of the step 76 of comparing, threshold values out of predetermined threshold values for complex impedance are selected in another step 78. If the determined complex impedance lies above the dash-dotted first line 52 in FIG. 2, threshold values that are represented by a dash-dotted second line 54 labeled “Low Load” are selected by the control and evaluation unit 26. This is shown in the upper part of the right-hand side of FIG. 2.

If the determined complex impedance lies below the dash-dotted first line 52 in FIG. 2, classification threshold values that are represented by a dash-dotted third line 56 labeled “High Load” are selected by the control and evaluation unit 26. This is shown in the lower part of the right-hand side of FIG. 2.

In another step 80, the signal processing unit 22 determines a complex sense current that is being generated in the first antenna electrode 18 of the capacitive sensor 16 in response to the periodic electrical measurement signal provided to the first antenna electrode 18 of the capacitive sensor 16. A complex impedance is determined from the complex sense current with reference to the complex reference potential in the following step 82.

In the next step 84 then, the control and evaluation unit 26 compares the complex impedance received by the signal processing unit 22 to the selected predetermined classification threshold values. For the sake of argumentation it shall be presumed that the dash-dotted second line 54 labeled “Low Load” has been selected by the control and evaluation unit 26. The diagram in the upper part of the right-hand side of FIG. 2 includes, besides the first zone 42 and also arranged above the dash-dotted second line 54, a third zone 46 that represents complex impedances to be expected with the seat occupant being a grounded human being. Arranged below the dash-dotted second line 54, the diagram includes a fourth zone 48 that represents complex impedances to be expected with the seat occupant being a non-grounded CRS 62.

The control and evaluation unit 26 determines a seat occupancy class in a next step 86, based on the result of the preceding step 84 of comparing and depending on a relation between the determined complex impedance and the selected predetermined threshold values for complex impedance. If, for instance, the complex impedance derived from the measured current through the first antenna electrode 18 lies within the third zone 46, the seat occupancy class “grounded human being” is selected.

In another step 88, the control and evaluation unit 26 generates a classification output signal 28 that is indicative of the determined seat occupancy class. The classification output signal 28 is transferred to the airbag control unit 60 to serve as a basis for a decision to deploy an air bag system to the vehicle seat.

The control and evaluation unit 26 is configured to automatically and periodically carry out the above-described method steps 70-88.

The diagram in the lower part of the right-hand side of FIG. 2 includes the third zone 46 arranged above a dash-dotted third line 56 and the fourth zone 48 arranged below the dash-dotted third line 56. Moreover, arranged below the dash-dotted third line 56 the diagram comprises the second zone 44 that represents complex impedances to be expected with the seat occupant being a grounded CRS 62.

FIG. 4 shows a second embodiment of the seat occupancy detection and classification system 10′ installed in the seat 34. In this embodiment, the first antenna electrode 18 is formed by an electrical seat heater member that is installed in the seat cushion 38 of the vehicle seat. The second antenna electrode 20 is formed by an electrical seat heater member that is installed in the backrest 40 of the vehicle seat. The method for operating the capacitive seat occupancy detection and classification system 10 disclosed herein as well applies to this alternative embodiment of the capacitive seat occupancy detection and classification system 10′.

Without giving a detailed description it is further contemplated that the second antenna electrode 20, with suitable electrical connections to the signal voltage source and to the sense current measurement means, can be employed in at least one operational mode of the seat occupancy detection and classification system 10, 10′ as an additional sense antenna electrode in the same way as the first antenna electrode 18, for improving a distinction performance regarding seat occupancy.

While the invention has been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting scope.

1. A capacitive sensing device for a seat occupancy detection and classification system, including
a capacitive sensor that includes at least a first electrically conductive antenna electrode and a second electrically conductive antenna electrode;
an impedance measurement circuit, comprising
a signal voltage source that is configured for providing, with reference to a ground potential, a periodic electrical measurement signal at an output port, and
at least one sense current measurement means that is configured to measure complex sense currents with reference to a reference voltage,
wherein the impedance measurement circuit is electrically connectable to said capacitive sensor such that
at least the first antenna electrode is electrically connectable to the output port for receiving the electrical measurement signal,
the second antenna electrode is electrically connectable via at least one controllable switch member either to the ground potential or to an electric AC potential of the output port,
wherein the complex sense currents are being generated in the capacitive sensor by the provided periodic measurement signal, and
a signal processing unit that is configured
to determine complex impedances from measured currents at least through the first antenna electrode with reference to the complex reference potential, and
to provide output signals that are representative of the determined complex impedances.

2. A seat occupancy detection and classification system, including
a capacitive sensing device as claimed in claim 1,
wherein the capacitive sensor is electrically connectable to the impedance measurement circuit such that a current through the second antenna electrode is measurable by said impedance measurement circuit, and
wherein the signal processing unit is further configured to at least determine a complex impedance from a measured current through the second antenna electrode determined with reference to the complex reference potential,
and
a control and evaluation unit that is configured
to receive the output signals provided by the signal processing unit,
dependent on a result of the complex impedance from the measured current through the second antenna electrode, to select at least one threshold value out of predetermined threshold values for complex impedance,
to compare the complex impedances from the measured current through the first antenna electrode to the at least one selected predetermined threshold value, and,
based on the result of the comparing, to determine a seat occupancy class.

3. A seat occupancy detection and classification system, including
a capacitive sensing device as claimed in claim 1,
wherein the capacitive sensor is electrically connectable to the impedance measurement circuit such that the second antenna electrode is electrically connectable via the at least one controllable switch member either to the ground potential or to the electric AC potential of the output port, and
wherein the signal processing unit is further configured to at least determine a first complex impedance from a measured current through the first antenna electrode with the second antenna electrode being electrically connected to the ground potential, and to determine a second complex impedance from a measured current through the first antenna electrode with the second antenna electrode being electrically connected to the electric AC potential of the output port,
and
a control and evaluation unit that is configured
to receive the output signals provided by the signal processing unit,
dependent on a relation between the first and the second complex impedance, to select at least one threshold value out of predetermined threshold values for complex impedance,
to compare the complex impedances from the measured current through the first antenna electrode to the at least one selected predetermined threshold value, and,
based on the result of the comparing, to determine a seat occupancy class.

4. A seat occupancy detection and classification system, including
a capacitive sensing device as claimed in claim 1,
wherein the capacitive sensor is electrically connectable to the impedance measurement circuit such that the second antenna electrode is electrically connectable via the at least one controllable switch member alternately to the ground potential and to the electric AC potential of the output port, and
wherein the signal processing unit is further configured to at least determine a difference between a first complex impedance of the first antenna electrode with the second antenna electrode being electrically connected to the ground potential and a second complex impedance of the first antenna electrode with the second antenna electrode being electrically connected to the electric AC potential of the output port,
and
a control and evaluation unit that is configured
to receive the output signals provided by the signal processing unit, dependent on the difference between the first and the second complex impedance, to select at least one threshold value out of predetermined threshold values for complex impedance,
to compare the complex impedances from the measured current through the first antenna electrode to the at least one selected predetermined threshold value, and,
based on the result of the comparing, to determine a seat occupancy class.

5. The seat occupancy detection and classification system as claimed in claim 3, wherein the capacitive sensing device comprises at least one remote controllable switch member and the seat occupancy detection and classification system comprises a switch remote control unit for remotely controlling the at least one remote controllable switch member.

6. The capacitive seat occupancy detection and classification system as claimed in claim 5, wherein the switch remote control unit is configured to periodically switch the remote controllable switch member to change an electrical connection of the second antenna electrode from being electrically connected to the electric ground potential to being electrically connected to the electric AC potential of the output port for a predetermined time period and back to being electrically connected to the electric ground potential after the time period has elapsed.

7. The capacitive seat occupancy detection and classification system as claimed in claim 2, further comprising a capacitive sensor, wherein the capacitive sensor is electrically connected at least to the output port of the signal voltage source and to the sense current measurement means.

8. The capacitive seat occupancy detection and classification system as claimed in claim 2, wherein the control and evaluation unit is configured to generate a classification output signal that is indicative of the determined seat occupancy class.

9. The capacitive seat occupancy detection and classification system as claimed in claim 2, wherein the at least one threshold value out of predetermined threshold values for complex impedance can be represented by a line in a two-dimensional graph spanned by a real part and an imaginary part of the complex impedance.

10. A method of operating the capacitive seat occupancy detection and classification system as claimed in claim 2, including steps of
providing a periodic electrical measurement signal to the first antenna electrode of the capacitive sensor,
determining a complex sense current that is being generated in the second antenna electrode of the capacitive sensor in response to the periodic electrical measurement signal provided to the first antenna electrode of the capacitive sensor,
comparing the determined complex sense current to at least one predetermined threshold value for the complex sense current,
depending on the result of the step of comparing, selecting at least one threshold value out of predetermined threshold values for complex impedance,
determining a complex sense current that is being generated in the first antenna electrode of the capacitive sensor in response to the periodic electrical measurement signal provided to the first antenna electrode of the capacitive sensor,
determining a complex impedance from the complex sense current in the first antenna electrode measured with reference to the complex reference potential,
comparing the determined complex impedance to the at least one selected predetermined threshold value for complex impedance, and
determining a seat occupancy class for the determined complex impedance depending on a relation between the determined complex impedance and the at least one selected predetermined threshold value for complex impedance.

11. A method of operating the capacitive seat occupancy detection and classification system as claimed in claim 3, including steps of
providing a periodic electrical measurement signal to the first antenna electrode of the capacitive sensor,
electrically connecting the second antenna electrode to the ground potential,
determining a first complex sense current that is being generated in the first antenna electrode of the capacitive sensor in response to the periodic electrical measurement signal provided to the first antenna electrode of the capacitive sensor,
determining a first complex impedance from the determined first complex sense current in the first antenna electrode measured with reference to the complex reference potential,
changing the electrically connection of the second antenna electrode from the ground potential to the electric AC potential of the output port,
determining a second complex sense current that is being generated in the first antenna electrode of the capacitive sensor in response to the periodic electrical measurement signal provided to the first antenna electrode of the capacitive sensor,
determining a second complex impedance from the determined first complex sense current in the first antenna electrode measured with reference to the complex reference potential,
determining a difference of the first complex impedance and the second complex impedance,
comparing the determined difference of the first complex impedance and the second complex impedance to at least one predetermined threshold value for the difference of complex impedance,
depending on the result of the step of comparing, selecting at least one threshold value out of predetermined threshold values for complex impedance,
comparing the determined first complex impedance to the at least one selected predetermined threshold value for complex impedance,
determining a seat occupancy class for the determined first complex impedance depending on at least one relation between the determined first complex impedance and the at least one selected predetermined threshold value for complex impedance.

12. A method of operating the capacitive seat occupancy detection and classification system as claimed in claim 4, including steps of
providing a periodic electrical measurement signal to the first antenna electrode of the capacitive sensor,
alternately connecting the second antenna electrode to the ground potential and to the electric AC potential of the output port,
determining a difference between a first complex impedance of the first antenna electrode with the second antenna electrode being electrically connected to the ground potential and second complex impedance of the first antenna electrode with the second antenna electrode being electrically connected to the electric AC potential of the output port,
comparing the determined difference of the first complex impedance and the second complex impedance to at least one predetermined threshold value for the difference of complex impedance,
depending on the result of the step of comparing, selecting at least one threshold value out of predetermined threshold values for complex impedance,
comparing the determined first complex impedance to the at least one selected predetermined threshold value for complex impedance,
determining a seat occupancy class for the determined first complex impedance depending on at least one relation between the determined first complex impedance and the at least one selected predetermined threshold value for complex impedance.

13. A vehicle seat, comprising
a seat cushion having at least one seat foam member,
a seat base configured for receiving at least a portion of the seat cushion, the seat base and the seat cushion being provided for supporting a bottom of a seat occupant,
a backrest that is provided for supporting a back of the seat occupant, and
a seat occupant detection and classification system as claimed in claim 2, wherein the capacitive sensor is arranged at at least one out of the seat cushion and the backrest.

14. The seat as claimed in claim 13, wherein at least one out of the first antenna electrode and the second antenna electrode is formed by an electrical seat heater member that is installed in the seat.

15. A non-transitory, computer readable medium for carrying out the method as claimed in claim 10, wherein the method steps are stored on the computer readable medium as program code that is executable by a processor unit of the capacitive seat occupancy detection and classification system or a separate control unit.

16. Use of the capacitive seat occupancy detection and classification system as claimed in claim 2 in a vehicle seat that includes
a seat structure for erecting the vehicle seat on a passenger cabin floor of the vehicle,
a seat cushion having at least one seat foam member,
a seat base supported by the seat structure and configured for receiving the seat cushion, the seat base and the seat cushion being provided for supporting a bottom of a seat occupant,
a backrest that is provided for supporting a back of the seat occupant,
wherein the capacitive sensor member is arranged at at least one out of the seat cushion and the backrest.
